(19) United States
(12) Patent Application Publication
(10) Pub. No.: US 2026/0150806 A1
(43) Pub. Date: Jun. 4, 2026

(54) PET CARRIER

(71) Applicant: Jiangsu Wellspring PET Articles Co., Ltd., Yancheng (CN)

(72) Inventor: Bin QIU, Yancheng (CN)

(21) Appl. No.: 19/404,293

(22) Filed: Dec. 1, 2025

(30) Foreign Application Priority Data
Dec. 2, 2024 (CN) 202422955576.5

(51) Int. Cl. A01K 1/02

(52) U.S. Cl. CPC A01K 1/0245

(57) ABSTRACT

Provided is a pet carrier, including a main body; a first frame attached to the main body and configured to pivot between an unfolded position and a folded position relative to the main body; a second frame which is foldable and is attached to the main body, where the second frame and the first frame are releasably connected to each other, and in the unfolded position, the first frame is enabled to be connected to the main body, the second frame is unfolded, and the pet carrier is in a first state, and in the folded position, the first frame is pivoted toward an interior of the main body, the second frame is folded toward the interior of the main body, and the pet carrier is in a second state; and a locking device which is movable between a locked position and an unlocked position.

### CROSS REFERENCE TO THE RELATED APPLICATIONS

This application is based upon and claims priority to Chinese Patent Application No. 202422955576.5, filed on Dec. 2, 2024, the entire contents of which are incorporated herein by reference.

### TECHNICAL FIELD

The present disclosure belongs to the technical field of pet products, and specifically relates to a pet carrier.

### BACKGROUND

When taking pets out for leisure, pet owners usually use pet crates to carry pets for convenience, including a pet carrier. The pet carrier is a purpose-built pet crate designed to transport a pet safely by plane, train, or car. However, existing pet carriers often have a fixed size and occupy much space, making it inconvenient to pack and transport.

### SUMMARY

An objective of the present disclosure is to provide a pet carrier to solve the above problem in the prior art.

A pet carrier is provided, including: a main body;
a first frame, where the first frame is attached to the main body and is configured to pivot between an unfolded position and a folded position relative to the main body;
a second frame, where the second frame is foldable and is attached to the main body, and the second frame and the first frame are releasably connected to each other,
where in the unfolded position, the first frame is enabled to be connected to the main body, the second frame is unfolded, and the pet carrier is in a first state, and in the folded position, the first frame is pivoted toward an interior of the main body, the second frame is folded toward the interior of the main body, and the pet carrier is in a second state; and
a locking device, where the locking device is movable between a locked position and an unlocked position, when the locking device is in the locked position, the locking device locks the first frame in the unfolded position or the folded position, and when the locking device is in the unlocked position, the first frame is pivotable between the unfolded position and the folded position relative to the main body.

In an embodiment, the first state is an unfolded state of the pet carrier.

In an embodiment, the second state is a folded state of the pet carrier.

In an embodiment, the main body is provided with a groove, and the groove is configured to receive the locking device therein.

In an embodiment, the locking device includes two locking pins attached to the first frame, the first frame includes a cavity, the cavity is configured to receive the two locking pins therein, the two locking pins are retracted into the cavity when the locking device is in the unlocked position, and the two locking pins extend out of the cavity and are connected to an interior of the groove when the locking device is in the locked position.

In an embodiment, the pet carrier further includes a first retaining member, and the first retaining member is configured to retain the locking device in the locked position.

In an embodiment, the first retaining member includes a spring attached between the two locking pins.

In an embodiment, the pet carrier further includes a first fastening device, and the first fastening device is configured to lock the locking device in the unlocked position.

In an embodiment, the first fastening device includes a fastening block attached to an interior of the cavity and a second retaining member attached between the fastening block and the cavity, and when the locking device is in the unlocked position, the fastening block is connected to the two locking pins via a force applied by the second retaining member.

In an embodiment, the second retaining member is a spring.

In an embodiment, the pet carrier further includes a touch member, and when the locking device is in the locked position, a locking of the locking device by the first fastening device is released via a force applied by the touch member to enable the locking device to lock the first frame in the unfolded position or the folded position.

In an embodiment, the touch member includes a protrusion arranged on the main body, and when the locking device is in the locked position, the fastening block is released from the two locking pins via a force applied by the protrusion.

In an embodiment, the pet carrier further includes a second fastening device, and the second fastening device is configured to retain the pet carrier in the second state.

In an embodiment, the main body includes at least two covers, and the first frame and the second frame are attached between the at least two covers.

In an embodiment, the second frame includes side frames and connection members, and each of the side frames is pivotably attached to a respective one of the at least two covers and two adjacent ones of the side frames are rotatably connected by a respective one of the connection members.

In an embodiment, the second fastening device includes a fastener attached to at least one cover of the at least two covers and a connection groove provided on at least one other cover of the at least two covers, the fastener is released from the connection groove in the first state, and the fastener is connected to the connection groove in the second state.

In conclusion, the present disclosure has the following advantages.

1. In the pet carrier of the present disclosure, the first frame is pivoted toward the interior of the main body, and the second frame is folded toward the interior of the main body, so that the pet carrier is changed from the first state (unfolded state) to the second state (folded state). The pet carrier in the folded state occupies a small space and may be conveniently packed and transported.

2. The first retaining member of the pet carrier of the present disclosure may retain the locking device in the locked position to prevent the locking device from being unlocked unintentionally.

3. In the pet carrier of the present disclosure, the locking device may be locked in the unlocked position by the first fastening device, so that the locking device does not need to be manually retained in the unlocked position during the pivoting of the first frame between the unfolded position and the folded position.

4. In the pet carrier of the present disclosure, the locking of the locking device by the first fastening device is released via a force applied by the touch member to enable the locking device to automatically lock the first frame in the unfolded position or the folded position. In addition, locking the first frame in the folded position may prevent the first frame from accidentally falling and pinching a hand of a user.

### BRIEF DESCRIPTION OF THE DRAWINGS

FIG. 1 is a schematic view of a pet carrier in a first state according to an embodiment.

FIG. 2 is a schematic view of a pet carrier changing from a first state to a second state according to an embodiment.

FIG. 3 is a schematic view of a pet carrier in a second state according to an embodiment.

FIG. 4 is a schematic view of a locking device in a locked position of the pet carrier of the embodiment shown in FIG. 1.

FIG. 5 is a schematic view of the locking device being locked in an unlocked position by a first fastening device in the pet carrier of the embodiment shown in FIG. 1.

FIG. 6 is a schematic view of locking of the locking device by the first fastening device being released via a force applied by a touch member in the pet carrier of the embodiment shown in FIG. 3.

### DETAILED DESCRIPTION OF THE EMBODIMENTS

In the following description, numerous specific details are given to provide a more thorough understanding of the present disclosure. However, it will be apparent to those skilled in the art that the present disclosure can be practiced without one or more of these details. In some other examples, to avoid confusion with the present disclosure, some technical features well known in the art are not described.

### Embodiment 1

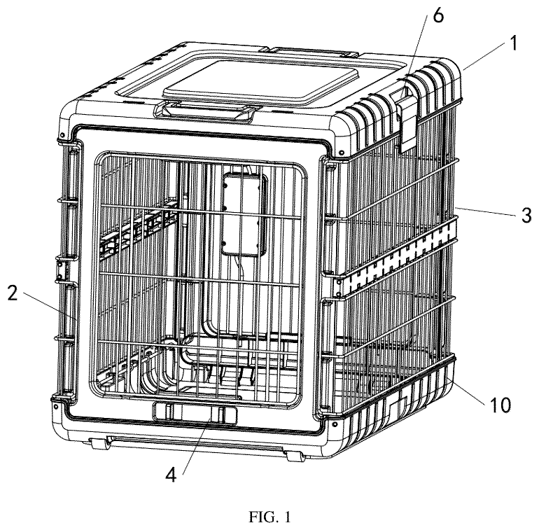

As shown in FIG. 1 to FIG. 3, this embodiment provides a folding pet carrier, which includes a main body 1, a first frame 2, a second frame 3, and a locking device 4. The first frame 2 is attached to the main body 1 and is configured to pivot between an unfolded position and a folded position relative to the main body 1. The second frame 3 is foldable and is attached to the main body 1. The second frame 3 and the first frame 2 are releasably connected to each other. In the unfolded position, the first frame 2 is enabled to be connected to the main body 1, the second frame 3 is unfolded, and the pet carrier is in a first state. In the folded position, the first frame 2 is pivoted toward an interior of the main body 1, the second frame 3 is folded toward the interior of the main body 1, and the pet carrier is in a second state. The locking device 4 is movable between a locked position and an unlocked position. When the locking device 4 is in the locked position, the locking device 4 locks the first frame 2 in the unfolded position or the folded position. When the locking device 4 is in the unlocked position, the first frame 2 is pivotable between the unfolded position and the folded position relative to the main body 1. The first state is an unfolded state of the pet carrier. The second state is a folded state of the pet carrier. The pet carrier in the folded state occupies a small space and may be conveniently packed and transported.

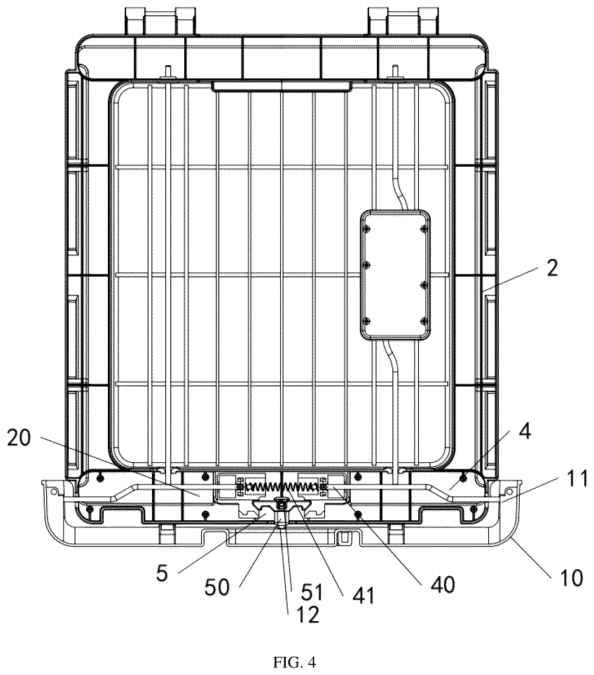

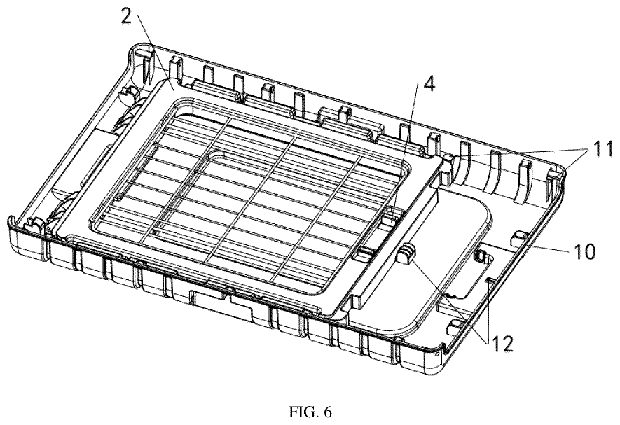

As shown in FIG. 4 and FIG. 6, the main body 1 is provided with a groove 11 configured to receive the locking device 4 therein, the locking device 4 includes two locking pins 40 attached to the first frame 2, and the first frame 2 includes a cavity 20 configured to receive the two locking pins 40 therein. When the locking device 4 is in the unlocked position, the two locking pins 40 are retracted into the cavity 20, so that the first frame 2 is pivotable between the unfolded position and the folded position relative to the main body 1. When the locking device 4 is in the locked position, the two locking pins 40 extend out of the cavity 20 and are connected to an interior of the groove 11, so that the first frame 2 is connected to the main body 1.

As shown in FIG. 4, the pet carrier further includes a first retaining member 41, and the first retaining member 41 is configured to retain the locking device 4 in the locked position to prevent the locking device 4 from being unlocked unintentionally. The first retaining member 41 includes a spring attached between the two locking pins 40.

As shown in FIG. 3, the pet carrier further includes a second fastening device 6 configured to retain the pet carrier in the second state. The second fastening device 6 can prevent the pet carrier in the second state from being unfolded unintentionally.

As shown in FIG. 1, the main body 1 includes two covers 10, and the first frame 2 and the second frame 3 are attached between the two covers 10.

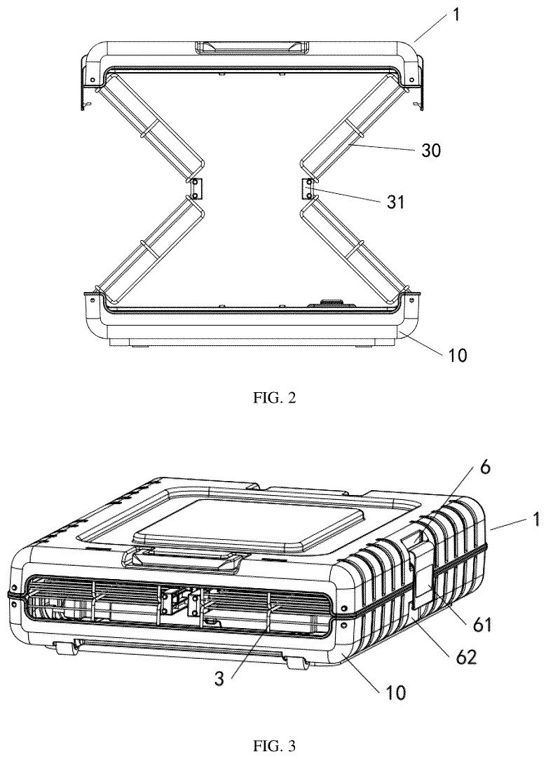

As shown in FIG. 2, the second frame 3 includes side frames 30 and connection members 31, and each of the side frames 30 is pivotably attached to a respective one of the two covers 10 and two adjacent ones of the side frames 30 are rotatably connected by a respective one of the connection members 31.

As shown in FIG. 1 and FIG. 3, the second fastening device 6 includes a fastener 61 attached to one of the two covers 10 and a connection groove 62 provided on the other of the two covers 10, the fastener 61 is released from the connection groove 62 in the first state, and the fastener 61 is connected to the connection groove 62 in the second state.

### Embodiment 2

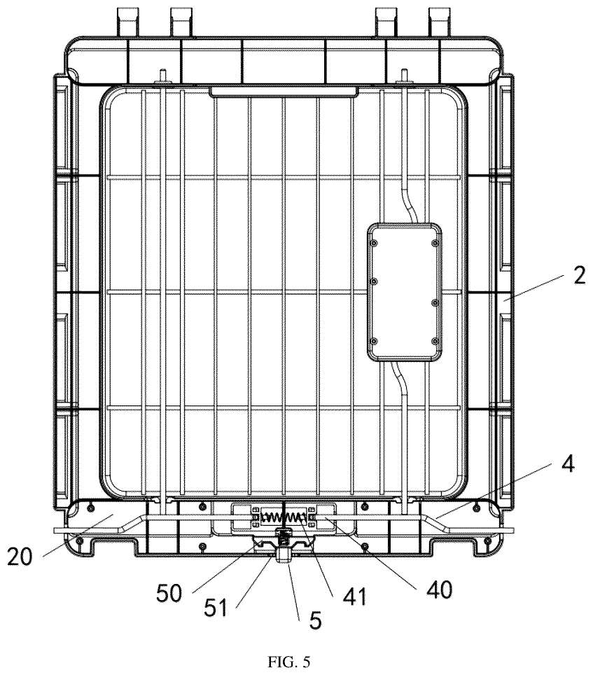

As shown in FIG. 4 and FIG. 5, different from Embodiment 1, the folding pet carrier provided in this embodiment further includes a first fastening device 5 configured to lock the locking device 4 in the unlocked position. The locking device 4 may be locked in the unlocked position by the first fastening device 5, so that the locking device 4 does not need to be manually retained in the unlocked position during the pivoting of the first frame 2 between the unfolded position and the folded position.

As shown in FIG. 4 and FIG. 5, the first fastening device 5 includes a fastening block 50 attached to an interior of the cavity 20 and a second retaining member 51 attached between the fastening block 50 and the cavity 20. When the locking device 4 is in the unlocked position, the fastening block 50 is connected to the two locking pins 40 via a force applied by the second retaining member 51, so that the locking device 4 is locked in the unlocked position by the first fastening device 5. The second retaining member 51 is a spring.

### Embodiment 3

As shown in FIG. 4 and FIG. 6, different from Embodiment 2, the folding pet carrier provided in this embodiment further includes a touch member 12. When the locking device 4 is in the locked position, the locking of the locking device 4 by the first fastening device 5 is released via a force applied by the touch member 12 to enable the locking device 4 to automatically lock the first frame 2 in the unfolded position or the folded position. In addition, locking the first frame 2 in the folded position may prevent the first frame 2 from accidentally falling and pinching a hand of a user.

As shown in FIG. 4 and FIG. 6, the touch member 12 includes a protrusion arranged on the main body 1. When the locking device 4 is in the locked position, the fastening block 50 is moved toward an interior of the cavity 20 via a force applied by the protrusion, so that the fastening block 50 is released from the two locking pins 40. Then, a force is applied to the two locking pins 40 by the first retaining member 41 to cause the two locking pins 40 to extend out of the cavity 20 and to be connected to the interior of the groove 11, thereby releasing the locking of the locking device 4 by the first fastening device.

Although preferred embodiments of the present disclosure have been described in detail above in conjunction with the accompanying drawings, the present disclosure is not limited to the specific details in the above embodiments. Various equivalent modifications can be made to the technical solutions of the present disclosure without departing from the scope of the technical concept of the present disclosure. Such equivalent modifications shall all fall within the protection scope of the present disclosure.

What is claimed is:

1. A pet carrier, comprising:
a main body;
a first frame, wherein the first frame is attached to the main body and is configured to pivot between an unfolded position and a folded position relative to the main body;
a second frame, wherein the second frame is foldable and is attached to the main body, and the second frame and the first frame are releasably connected to each other,
wherein in the unfolded position, the first frame is enabled to be connected to the main body, the second frame is unfolded, and the pet carrier is in a first state, and in the folded position, the first frame is pivoted toward an interior of the main body, the second frame is folded toward the interior of the main body, and the pet carrier is in a second state; and
a locking device, wherein the locking device is movable between a locked position and an unlocked position, when the locking device is in the locked position, the locking device locks the first frame in the unfolded position or the folded position, and when the locking device is in the unlocked position, the first frame is pivotable between the unfolded position and the folded position relative to the main body.

2. The pet carrier according to claim 1, wherein the first state is an unfolded state of the pet carrier.

3. The pet carrier according to claim 1, wherein the second state is a folded state of the pet carrier.

4. The pet carrier according to claim 1, wherein the main body is provided with a groove, and the groove is configured to receive the locking device therein.

5. The pet carrier according to claim 4, wherein the locking device comprises two locking pins attached to the first frame, the first frame comprises a cavity, the cavity is configured to receive the two locking pins therein, the two locking pins are retracted into the cavity when the locking device is in the unlocked position, and the two locking pins extend out of the cavity and are connected to an interior of the groove when the locking device is in the locked position.

6. The pet carrier according to claim 1, further comprising a first retaining member, wherein the first retaining member is configured to retain the locking device in the locked position.

7. The pet carrier according to claim 1, further comprising a first fastening device, wherein the first fastening device is configured to lock the locking device in the unlocked position.

8. The pet carrier according to claim 7, further comprising a touch member, wherein when the locking device is in the locked position, a locking of the locking device by the first fastening device is released via a force applied by the touch member to enable the locking device to lock the first frame in the unfolded position or the folded position.

9. The pet carrier according to claim 1, further comprising a second fastening device, wherein the second fastening device is configured to retain the pet carrier in the second state.
